(19) United States
(12) Patent Application Publication
(10) Pub. No.: US 2016/0357647 A1
(43) Pub. Date: Dec. 8, 2016

(54) COMPUTER, HYPERVISOR, AND METHOD FOR ALLOCATING PHYSICAL CORES

(71) Applicant: HITACHI, LTD., Tokyo (JP)

(72) Inventors: Yoshihide SHIRAI, Tokyo (JP); Hidetoshi SATO, Tokyo (JP)

(73) Assignee: HITACHI, LTD., Tokyo (JP)

(21) Appl. No.: 15/109,211

(22) PCT Filed: Feb. 10, 2014
(86) PCT No.: PCT/JP2014/052996

§ 371 Date: Jun. 30, 2016

(51) Int. Cl. G06F 11/20; G06F 9/50; G06F 9/455

(52) U.S. Cl. CPC G06F 11/2033; G06F 11/2028; G06F 9/45558; G06F 9/5077; G06F 2201/805; G06F 2201/815; G06F 2009/4557

(57) ABSTRACT

A computer, hypervisor, and method are disclosed for allocating physical cores for maintaining an OS without changing the number of logical cores even if physical cores become an obstacle, and for suppressing the performance of a virtual computer from deteriorating. The hypervisor allocates a first physical core to a first logical core of a first virtual machine, and allocates a plurality of physical cores to one or more logical cores of a second virtual computer. When an obstacle occurs in the first physical core, the hypervisor allocates, to one or more logical cores, the physical cores other than the second physical core among the plurality of physical cores allocated to the one or more logical cores of the second virtual computer. The hypervisor changes the physical core allocated to the first logical core from the first physical core in which the obstacle occurred to the second physical core.

### TECHNICAL FIELD

The present invention relates to a computer, a hypervisor, and a method for allocating physical cores.

### BACKGROUND ART

There is disclosed, by way of background of the art, Japanese Patent Application Publication No. 2008-40540 (Patent Document 1). This publication describes that “when a target machine which is one of running physical processors becomes degenerate due to a failure, the table content is updated regardless of the type of logical processor allocated to the degenerate processor, and a spare processor is incorporated as an alternative to the degenerate processor” (see the abstract).

### CITATION LIST

### Patent Document

Patent Document 1: Japanese Patent Application Publication No. 2008-40540

### SUMMARY OF INVENTION

### Technical Problem

According to Patent Document 1, in a computer with an OS (Operating System) running on a virtual computer in which a physical core is allocated to a logical core possessed by the virtual computer, when a failure occurs in the physical core and the physical core becomes degenerate, a spare physical core (spare processor) as an alternative to the particular logical core. However, according to Patent Document 1, for example, in the case of the OS that may not keep running when the number of logical cores changes, it is necessary to use a spare physical core and it is difficult to keep the OS running without the use of the spare physical core when the number of physical cores changes. Further, for example, even in the case of the OS that can keep running when the number of logical cores changes, there is a problem that the performance is deteriorated when the spare physical core is not used.

### Solution to Problem

In order to solve the above problems, the present invention has a hypervisor for allocating a first physical core to a first logical core possessed by a first virtual computer, and for allocating a plurality of physical cores to one or more logical cores possessed by a second virtual computer. When a failure occurs in the first physical core, the hypervisor allocates a physical core other than a second physical core among the plurality of physical cores allocated to one or more logical cores possessed by the second virtual computer, to one or more logical cores. The hypervisor changes the physical core to be allocated to the first logical core, from the first physical core in which the failure occurred to the second physical core.

### Advantageous Effects of Invention

Even if failure occurs in the physical core, it is possible to keep the OS running without the need to change the number of logical cores, preventing deterioration of the performance of the virtual computer. The problems, configurations and effects other than those described above will become apparent based on the following description of the preferred embodiment of the invention.

### BRIEF DESCRIPTION OF DRAWINGS

FIG. 1 A diagram showing the configuration of a computer system.

FIG. 2 A diagram showing the configuration of a hypervisor.

FIG. 3 A diagram showing the configuration of physical core management information.

FIG. 4 A diagram showing the configuration of physical core group management information.

FIG. 5 A diagram showing the configuration of logical core management information.

FIG. 6 A diagram showing the configuration of LPAR management information.

FIG. 7 A diagram of an example of the screen for displaying and setting the configuration of the LPAR.

FIG. 8 A flow chart (Part 1) showing control by a resource control unit.

FIG. 9 A flow chart (Part 2) showing control by the resource control unit.

FIG. 10 A flow chart (Part 3) showing control by the resource control unit.

FIG. 11 A flow chart (Part 4) showing control by the resource control unit.

FIG. 12 A diagram showing the configuration of the computer system after the control by the resource control unit, in the case where a physical core 0 becomes a failed physical core.

FIG. 13 A diagram showing the configuration of physical core management information in the case where the physical core 0 and physical core 1 become failed physical cores.

FIG. 14 A diagram showing the configuration of physical core group management information in the case where the physical core 0 and physical core 1 become failed physical cores.

FIG. 15 A diagram showing the configuration of logical core management information in the case where the physical core 0 and physical core 1 become failed physical cores.

FIG. 16 A diagram showing the configuration of the computer system after the control by the resource control unit, in the case where the physical core 0 and physical core 1 become failed physical cores.

### DESCRIPTION OF EMBODIMENTS

Hereinafter, the preferred embodiment will be described with reference to the accompanying drawings.

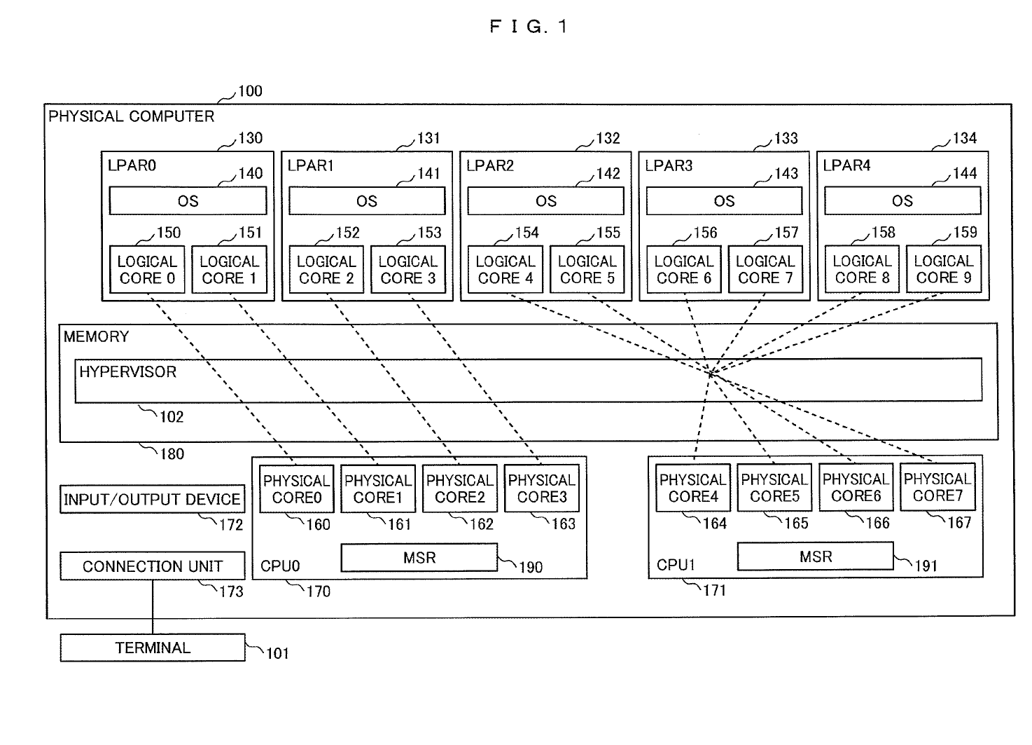

FIG. 1 is a diagram showing the configuration of a computer system. A physical computer 100 includes arithmetic operation units (CPU 0 170, CPU 1 171), a memory (storage unit) 180, an input/output device (input/output unit) 172, and a connection unit 173. Hereinafter, the CPU 0 170 and the CPU 1 171 will also be referred to as the CPUs 170 and 171.

The input/output device 172 is a device such as HBA (Host Bus Adapter) or NIC (Network Interface Card), which is connected to the storage, network, and the like. The connection unit 173 is connected to a terminal 101. The terminal 101 includes a display part for screen display, and an input part for receiving an instruction (or a request) from the user.

The memory 180 includes a hypervisor 102. The hypervisor 102 is a program that achieves virtualization and is executed by the CPUs 170 and 171. The hypervisor 102 generates LPARs (130 to 134) which are logical computers. Here, an LPAR (Logical Partition) is a logical partition to which the hardware is allocated in such a way that the resources (computer resources: physical CPU, physical memory, physical I/O, and the like) held by the hardware are logically divided by the hypervisor. The LPAR of the present embodiment can be defined as the logical computer (virtual computer).

In the present embodiment, the hypervisor 102 divides or shares the computer resources within the CPUs 170 and 171, such as physical cores (160 to 167), the memory 180, and the input/output device 172, and then allocates the computer resources to the LPARs (130 to 134). In this way, the hypervisor 102 controls the LPARs (130 to 134).

The LPAR 0 130 is provided with an OS (Operating System) 140 as well as a logical core 0 150 and a logical core 1 151. Similarly, as shown in FIG. 1, LPARs 1 to 4 (131 to 134) are provided with OSs 141 to 144 and logical cores 2 to 9 (152 to 159). The OSs 140 to 144 run on the LPARs 0 to 4 (130 to 134).

The CPU 0 170 is provided with an MSR (Model Specific Register) 190, which is a register of the hardware in which the status of the CPU 0 170 is recorded, and the physical cores 0 to 3 (160 to 163). Similarly, the CPU 1 171 is provided with an MSR 191 in which the status of the CPU 171 is recorded, and the physical cores 4 to 7 (164 to 167). In the MSRs 190 and 191, the number of occurrences of error (CE: Correctable Error) in the physical cores (160 to 167) within the same CPUs 170 and 171 is recorded.

In the present embodiment, it is assumed that CE has often occurred in a certain physical core and a failure occurred in the physical core. More specifically, it is assumed that when the number of occurrences of CE in a certain physical core exceeds a CE count threshold 123, a failure occurred in the physical core. In the description of the present embodiment, the physical core exceeding the CE count threshold 123 is referred to as the failed physical core.

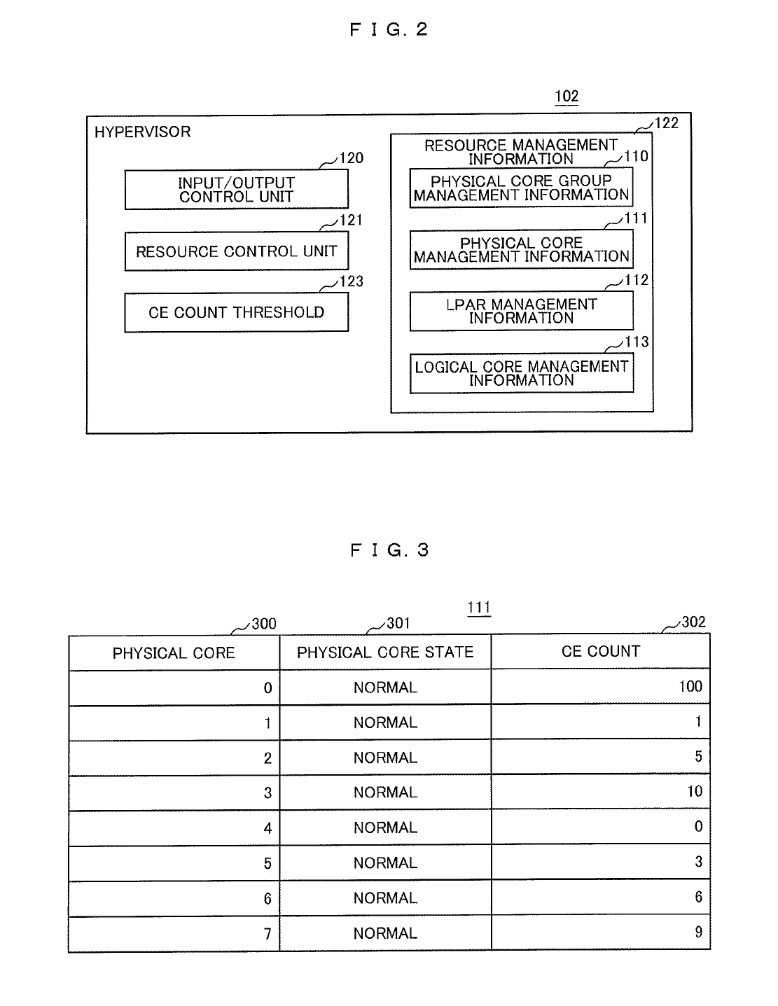

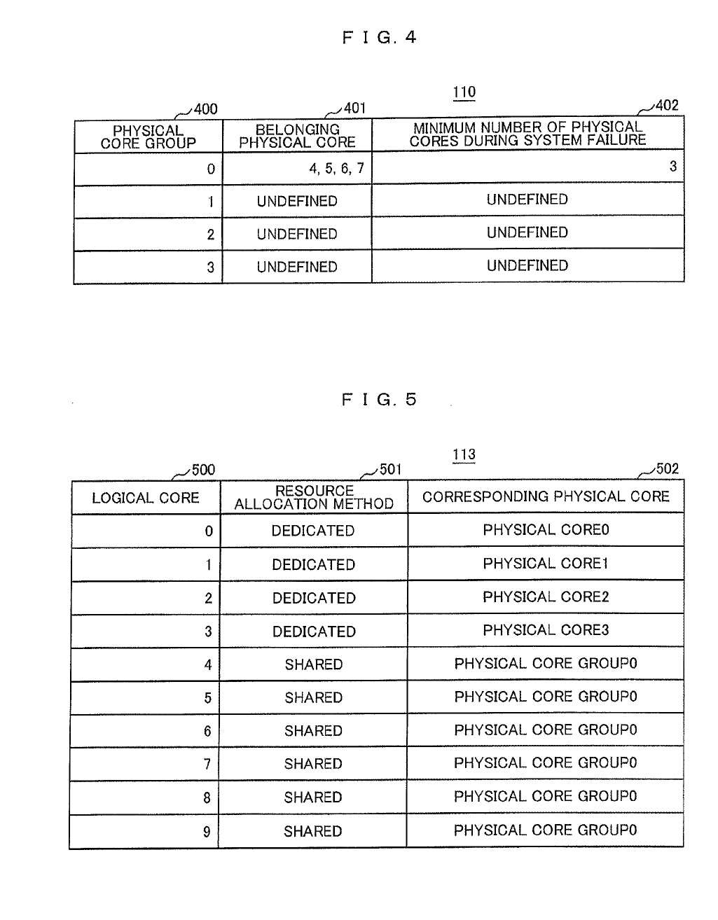

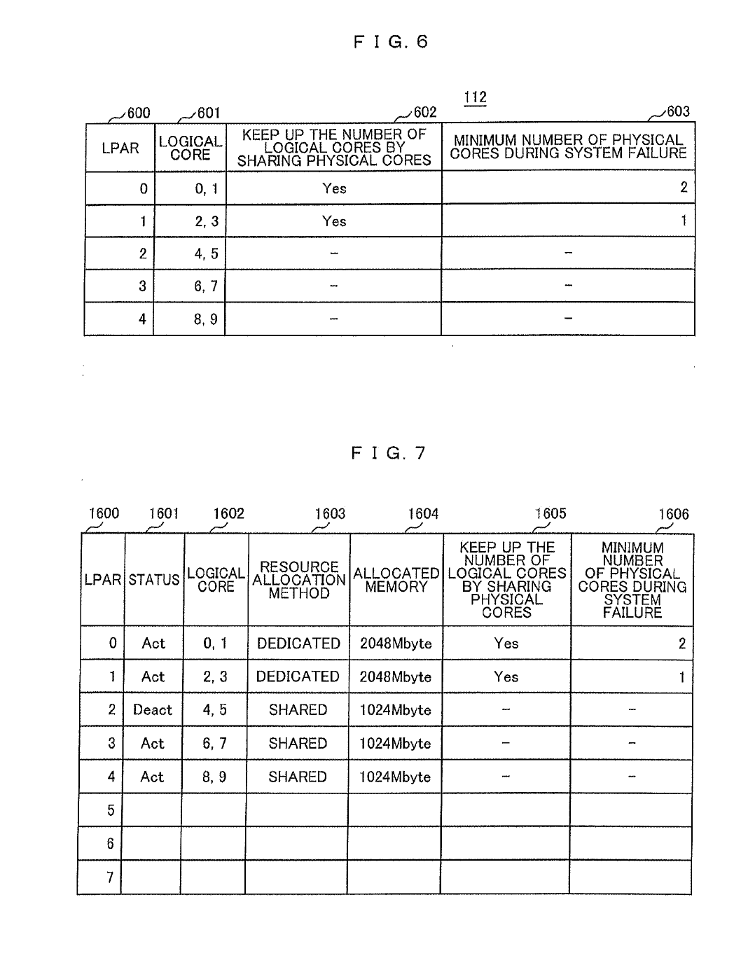

FIG. 2 is a diagram showing the configuration of the hypervisor 102. The hypervisor 102 includes: resource management information 122 for managing the physical computer resources and the logical computer resources; an input/output control unit 120 for controlling input and output from and to the terminal 101; a resource control unit 121 for controlling the resource management information 122; and the CE count threshold 123 which is a predetermined value. The resource management information 122 includes physical core group management information 110 (FIG. 4), physical core management information 111 (FIG. 3), LPAR management information 112 (FIG. 6), and logical core management information 113 (FIG. 5).

The resource management information 122 and the CE count threshold 123 which is a predetermined value are not necessarily located within the hypervisor 102 and can be located in an external storage device connected to the memory 102 and the physical computer 100.

The number of LPARs on the hypervisor 102 and the maximum number of logical cores configuring the LPARs are determined according to the maximum number defined in the system. In the present embodiment, it is assumed that there are five LPARs (130 to 134) on the hypervisor 102, and that the logical cores (150 to 159) are provided, two by two, in each of the LPARs.

FIG. 3 is a diagram showing the configuration of the physical core management information 111. The physical core management information 111 has entries with respect to each of the physical cores 0 to 7 (160 to 167), including a physical core identifier 300 for identifying each physical core, a physical core state 301, and a CE count 302, which are managed in association with each other. For example, in the case of the physical core 2 162, the physical core state 301 is “normal” and the CE count 302 is “5”.

FIG. 4 is a diagram showing the configuration of the physical core group management information 110. The physical core group management information 110 has entries, including a physical core group identifier 400 for identifying each physical core group, a belonging physical core 401 which is a physical core belonging to the physical core group, and a minimum number of physical cores during system failure 402, which are managed in association with each other. For example, the physical core group is configured with physical cores 4 to 7 (164 to 167), for which the minimum number of physical cores during system failure is “3”.

FIG. 5 is a diagram showing the configuration of the logical core management information 113. The logical core management information 113 has entries with respect to each of the logical cores 0 to 9 (150 to 159), including a logical core identifier 500 for identifying each logical core, a resource allocation method 501, and a corresponding physical core 502, which are managed in association with each other. For the corresponding physical core 502, the identifier of the corresponding physical core is recorded when the resource allocation method 501 is DEDICATED, and the identifier of the corresponding physical core group is recorded when the resource allocation method 501 is SHARED.

In the case of the logical core 0 150, the resource allocation method 501 is DEDICATED and the physical core 0 160 is allocated. Similarly, in the case of the logical cores 1 to 3 (151 to 153), the resource allocation method 501 is DEDICATED and the physical cores 1 to 3 (161 to 163) are allocated to the individual logical cores.

Further, in the case of the logical cores 4 to 9 (154 to 159), the resource allocation method 501 is SHARED and the physical core group 0 is allocated. As described above, the physical core group 0 is configured with the physical cores 4 to 7 (164 to 167), in which the resources of the physical cores 4 to 7 (164 to 167) is time shared among the logical cores 4 to 9 (154 to 159).

The resource control unit 121 of the hypervisor 102 allocates the logical cores 0 to 9 (150 to 159) to the physical cores or physical core groups. In FIGS. 1, 12, and 16, the allocation of the physical cores to the logical cores is shown by the dashed lines.

FIG. 6 is a diagram showing the configuration of the LPAR management information 112. The LPAR management information 112 has entries with respect to each of the LPARs 0 to 4 (130 to 134), including an LPAR identifier 600 for identifying each LPAR, a logical core identifier 601 for identifying the logical core possessed by the LPAR, “keep up the number of logical cores by sharing physical cores” 602 which is the information indicating whether or not to keep the number of logical cores by sharing physical cores, and a minimum number of physical cores during system failure 603, which are managed in association with each other.

For example, the LPAR 0 130 has the logical core 0 150 and the logical core 1 151. The LPAR 0 130 is the policy to keep the number of logical cores by sharing physical cores, for which the minimum number of physical cores during system failure 603 is “2”.

FIG. 7 is a diagram showing an example of the screen for displaying and setting the configuration of the LPAR. The operator (user, administrator) can check and change the configuration of the LPAR by using the screen displayed in the terminal 101.

The screen shown in FIG. 7 includes: an LPAR identifier 1600; an LPAR status 1601; a logical core 1602 possessed by the LPAR; a resource allocation method 1603; an allocation memory 1604; “keep up the number of logical cores by sharing physical cores” 1605 which is the information indicating whether or not to keep the number of cores by sharing physical core; and a minimum number of physical cores during system failure 1606. The resource management information 122 has information equivalent to the respective information 1600 to 1606. The input/output control unit 120 generates the screen shown in FIG. 7 based on the resource management information 122, and displays the screen in the terminal 101.

In the case where the operator wants to keep the processing performance of the LPAR even upon occurrence of a failure in the physical core, the operator inputs the value equal to the number of physical cores belonging to the particular LPAR, to the minimum number of physical cores during system failure 1606 from the terminal 101. Further, when the OS running on the LPAR is down due the change in the number of cores in operation, the operator inputs YES to “keep up the number of logical cores by sharing physical cores 1605” from the terminal 101. On the other hand, in the case of the OS that can keep running when the number of logical cores changes, the operator inputs NO to “keep up the number of logical cores by sharing physical cores 1605” from the terminal 101.

When the “keep up the number of logical cores by sharing physical cores 1605” and the “minimum number of physical cores during system failure 1606” are input from the terminal 101, the input/output control unit 120 receives the input data through the connection unit 173 and transfers to the resource control unit 121. The resource control unit 121 stores the received “keep up the number of logical cores by sharing physical cores 1605” and the received “minimum number of physical cores during system failure 1606”, into the “keep up the number of logical cores by sharing physical cores 602” and “minimum number of physical cores during system failure 603” of the LPAR management information 112.

The operator (user, administrator) can select the LPAR in which the operator wants to keep the performance during system failure, by an input to the “keep up the number of logical cores by sharing physical cores 1605” and to the “minimum number of physical cores during system failure 1606”. For example, with respect to the LPAR in which the operator wants to keep the performance during system failure, when the operator sets the “minimum number of physical cores during system failure 1606” to the value equal to the number of physical cores allocated to the logical core possessed by the particular LPAR before the occurrence of the failure, the number of physical cores can be kept even during system failure.

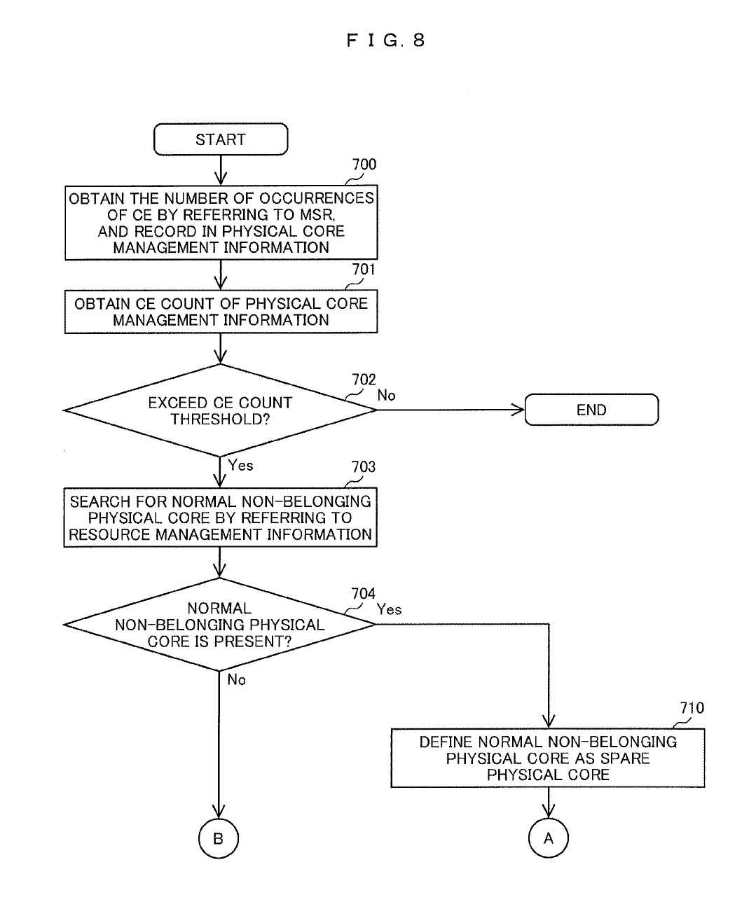

FIGS. 8 to 11 are flow charts showing control provided by the resource control unit 121.

First, based on the flow chart of FIG. 8, the operation of the resource control unit 121 will be described. In Step 700, the resource control unit 121 refers to the MSRs 190 and 191 within the CPUs 170 and 171 to obtain the number of occurrences of CE in each of the physical cores 0 to 7 (160 to 167). The resource control unit 121 maps the corresponding physical core identifier 300 to the CE count 302 of the physical core management information 111, and records the obtained number of occurrences of CE. This step can be performed periodically or at random intervals.

In Step 701, the resource control unit 121 refers to the physical core management information 111 to obtain the CE count 302 of the respective physical cores 0 to 7 (160 to 167).

In Step 702, the resource control unit 121 compares the CE count 302 of the respective physical cores 0 to 7 (160 to 167) with the CE count threshold 123. As a result of the comparison, when the CE count 302 in each physical core does not exceed the CE count threshold 123, the resource control unit 121 ends the sequence, while if the CE count 302 exceeds the CE count threshold 123, the resource control unit 121 proceeds to Step 703. The physical core in which the CE count 302 exceeds the CE count threshold 123 is defined as the failed physical core.

In Step 703, the resource control unit 121 refers to the column of the belonging physical core 401 of the physical core group management information 110, as well as the column of the corresponding physical core 502 of the logical management information 113 to search for non-belonging physical cores that are not present in both the columns 401 and 502, among the physical cores 0 to 7 (160 to 167). The non-belonging physical cores are physical cores that are not allocated to any of the logical cores 0 to 9 (150 to 159). Further, if a non-belonging physical core is present, the resource control unit 121 refers to the physical core management information 111 to determine whether or not the physical core state 301 of the non-belonging physical core is normal.

In Step 704, as a result of the searching for non-belonging normal physical cores, if a non-belonging normal physical core is present, the resource control unit 121 proceeds to Step 710, while if there is no non-belonging normal physical core, the resource control unit 121 proceeds to Step 730.

In Step 710, the resource control unit 121 defines the non-belonging normal physical core found in Step 704 as a spare physical core, and then, moves to Step 720.

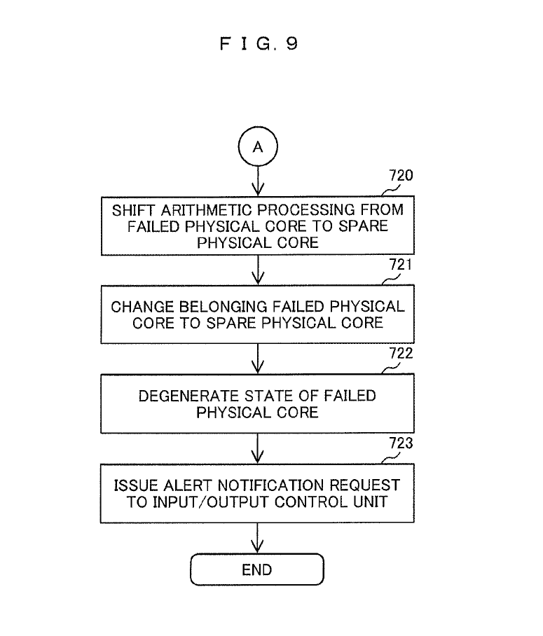

Next, the operation of the resource control unit 121 will be described based on the flow chart of FIG. 9. In Step 720, the resource control unit 121 shifts the arithmetic processing from the failed physical core to the spare physical core.

In Step 721, the resource control unit 121 changes the belonging failed physical core to the spare physical core. The resource control unit 121 allocates the logical core allocated to the failed physical core to the spare physical core, and updates the logical core management information 113. Further, the resource control unit 121 changes the allocation of the physical core group to which the failed physical core belongs, from the failed physical core to the spare physical core, and updates the physical core group management information 110.

In Step 722, the resource control unit 121 puts the failed physical core into a degenerate state. The resource control unit 121 changes the (failed) physical core state 301, which is associated with the identifier 300 of the failed physical core, to “degenerate”.

In Step 723, the resource control unit 121 issues an alert notification request to the input/output control unit 120 to notify that the failed physical core has been switched to the spare physical core. Upon reception of the alert notification request, the input/output control unit 120 displays the screen in the terminal 101 through the connection unit 173, to notify that the configuration of the LPAR is changed because the failed physical core was detected. As a specific example, the screen to notify that a failed physical core has been detected and the allocation of the physical core to the logical core of the LPAR was changed from the failed physical core to the spare physical core. From the notification on the display, the operator (user, administrator) can know the occurrence of failure in the physical core as well as the change in the configuration of the LPAR.

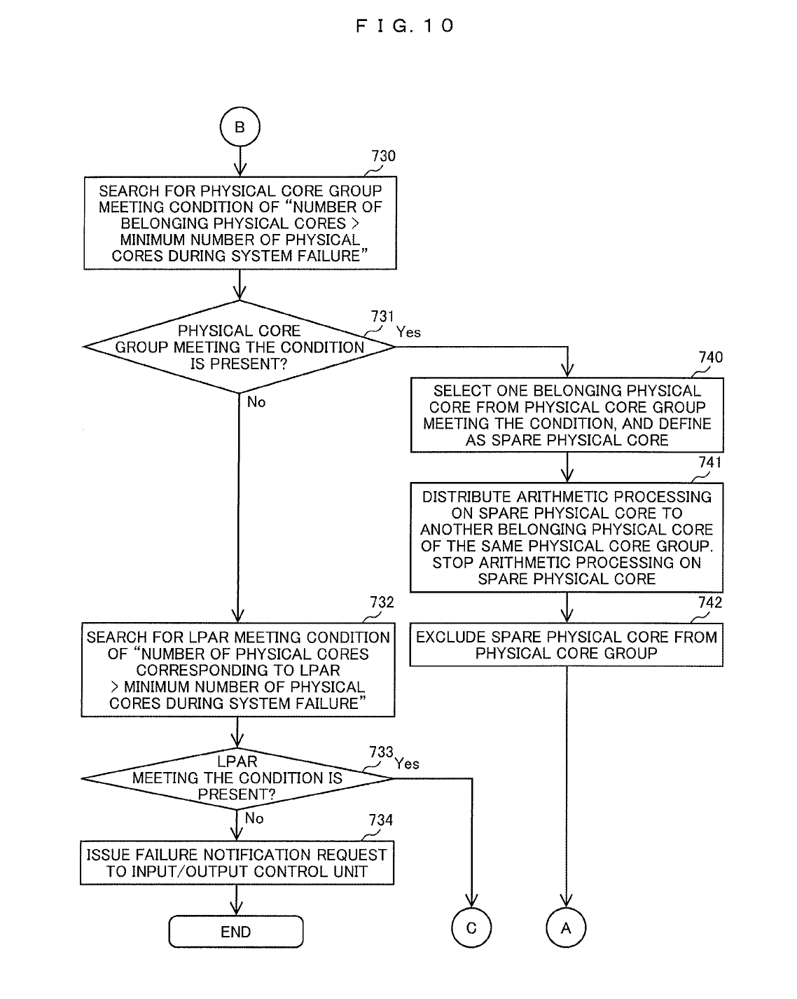

Next, the operation of the resource control unit 121 will be described based on the flow chart of FIG. 10. In Step 730, the resource control unit 121 refers to the physical core group management information 110 to search for the physical core group that meets the condition that “the number of the belonging physical cores 401 is greater than the minimum number of physical cores during system failure 402”.

In Step 731, the resource control unit 121 determines whether or not there is a physical core group that meets the condition that “the number of the belonging physical cores 401 is greater than the minimum number of physical cores during system failure 402” as a result of the search in Step 730. As a result of the determination, if there is a physical core group that meets the condition, the resource control unit 121 proceeds to Step 740, while if there is no physical core group that meets the condition, the resource control unit 121 proceeds to Step 732.

In Step 732, the resource control unit 121 refers to the physical core group management information 110, the LPAR management information 112, and the logical core management information 113, to search for an LPAR that meets the condition that “the number of physical cores allocated to the logical core possessed by the LPAR is greater than the minimum number of physical cores during system failure 603”.

In Step 733, if there is an LPAR that meets the condition that “the number of physical cores allocated to the logical core possessed by the LPAR is greater than the minimum number of physical cores during system failure 603” as a result of the search in Step 732, the resource control unit 121 proceeds to Step 750, while if there is no LPAR that meets the condition, the resource control unit 121 proceeds to Step 734.

In Step 734, the resource control unit 121 issues a failure notification request to the input/output control unit 120 to notify that it failed to switch the failed physical core. Upon receiving the failure notification request, the input/output control unit 120 displays the screen in the terminal 101 through the connection unit 173, to notify that a failed physical core was detected but it failed to change the allocation of the failed physical core to the logical core of the LPAR. From the notification on the screen, the operator (user, administrator) can know the occurrence of failure in the physical core as well as the fact that it failed to change the allocation of the failed physical core to the logical core.

In Step 740, the resource control unit 121 refers to the physical core group management information 110 with respect to the physical core group that meets the condition that “the number of the belonging physical cores 401 is greater than the minimum number of physical cores during system failure 402”, which was detected in Step 730. Then, the resource control unit 121 selects one of the belonging physical cores configuring the particular physical core group, and defines it as a spare physical core. At this time, for example, the resource control unit 121 can select the spare physical core from the belonging physical cores based on a predetermined condition (physical core performance, CE count, priority among physical cores, or the like). In this case, the resource management information 122 includes information such as the physical core performance and the priority among physical cores.

Note that when a plurality of physical core groups are detected in Step 730, the resource control unit 121 selects one physical core group based on a predetermined condition. For example, as a predetermined condition, the priority or performance among the physical core groups is defined in the physical core group management information 110, so that the resource control unit 121 can select one physical core group based on the priority or on the performance.

In Step 741, the resource control unit 121 refers to the physical core group management information 110 to distribute the arithmetic processing corresponding to the spare physical core to another belonging physical core 401 of the same physical core group. The arithmetic processing of the spare physical core is stopped.

In Step 742, the resource control unit 121 excludes the spare physical core from the physical core group, and updates the physical core group management information 110. Then, the resource control unit 121 proceeds to Sept 720.

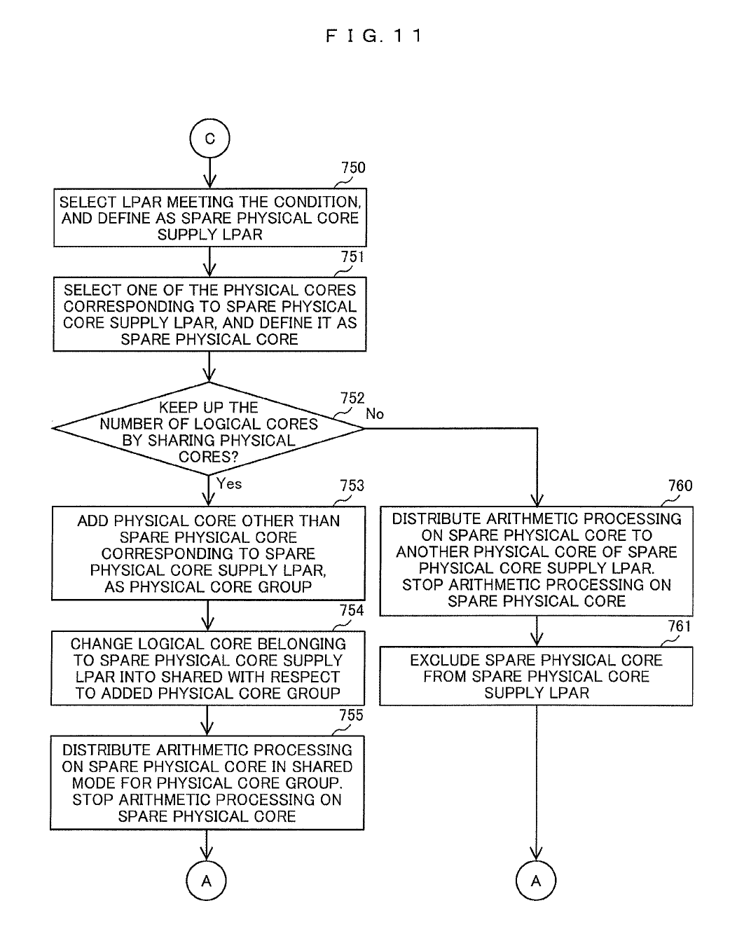

Next, the operation of the resource control unit 121 will be described based on the flow chart of FIG. 11. In Step 750, the resource control unit 121 selects one of the LPARs detected in Step 732, and defines as a spare physical core supply LPAR. Note that when a plurality of LPARs is detected in Step 732, the resource control unit 121 selects one LPAR according to a predetermined condition. For example, it is possible that the priority or performance among LPARs is defined as a predetermined condition in the LPAR management information 112 and that the resource control unit 121 selects one LPAR based on the priority or on the performance.

In Step 751, the resource control unit 121 refers to the resource management information 122 to select one physical core among the physical cores allocated to the logical core possessed by the spare physical core supply LPAR. Then, the resource control unit 121 defines the selected physical core as a spare physical core. At this time, for example, the resource control unit 121 can select the spare physical core based on a predetermined condition (physical core performance, CE count, priority among physical cores, or the like). In this case, the resource management information 122 includes information such as the physical core performance and the priority among physical cores.

In Step 752, the resource control unit 121 refers to “keep up the number of logical cores by sharing physical cores” 602 of the LPAR management information 112. If the answer is YES, the resource control unit 121 proceeds to Step 753, while if NO, it proceeds to Step 760.

In Step 753, the resource control unit 121 adds all the physical cores, except for the spare physical core, of the physical cores allocated to the logical core possessed by the spare physical core supply LPAR, to the physical core group management information 110 as one physical core group. Here, the minimum number of physical cores during system failure 402 of the physical core group to be added inherits the minimum number of physical cores during system failure 603 of the spare physical core supply LPAR.

In Step 754, the resource control unit 121 allocates all the logical cores possessed by the spare core supply LPAR into the physical core group added in Step 753. The resource control unit 121 records the physical core group added in Step 753 into the corresponding physical core 502 that corresponds to the logical core possessed by the spare core supply LPAR, in the logical core management information 113. Then, the resource control unit 121 sets the resource allocation method 501 to SHARED.

In Step 755, the resource control unit 121 puts the physical core group added in Step 753 into SHARED mode. Then, the resource control unit 121 distributes the arithmetic processing of the spare physical core, to the physical core belonging to the particular physical core group. Further, the resource control unit 121 stops the arithmetic processing of the spare physical core, and then proceeds to Step 720.

In Step 760, the resource control unit 121 refers to the resource management information 122, and distributes the arithmetic processing of the spare physical core to another physical core allocated to the logical core possessed by the spare physical core supply LPAR. Then, the resource control unit 121 stops the arithmetic processing of the spare core.

In Step 761, the resource control unit 121 excludes the spare physical core from the logical core possessed by the spare physical core supply LPAR, and updates the logical management information 113 and the physical core group management information 110, and then proceeds to Step 720.

The description will assume that in the sequence diagram of FIGS. 8 to 11 with the configuration of the computer system of FIG. 1, CE often occurred in the physical core 0 160 and, as a result, the physical core 0 160 becomes a failed physical core.

In Step 700, the resource control unit 121 refers to the MSR 190 of the CPU 0 170 to obtain the number of occurrences of CE in the physical core 0 160. The resource control unit 121 maps the identifier “0” of the physical core 0 160 to the CE count 302 of the physical core management information 111. Then, the resource control unit 121 records the obtained number of occurrences of CE.

In Step 701, the resource control unit 121 refers to the physical core management information 111 (FIG. 3) to obtain the CE count 302 of the physical core 0 160.

In Step 702, the resource control unit 121 compares the CE count 302 of the physical core 0 160 to the CE count threshold 123. In the present embodiment, the resource control unit 121 determines that the value “100” of the CE count 302 of the physical core 0 160 exceeds the CE count threshold 123, and proceeds to Step 703.

In Step 703, the resource control unit 121 refers to the column 401 of the belonging physical core of the physical core group management information 110 (FIG. 4), as well as the column 502 of the corresponding physical core of the logical core management information 113 (FIG. 5), to search for a non-belonging physical core among the physical cores 0 to 7 (160 to 167).

In Step 704, no non-belonging physical core was found as a result of the search in Step 703, so that the resource control unit 121 proceeds to Step 730.

In Step 703, the resource control unit 121 refers to the physical core group management information 110 to search for a physical core group that meets the condition that “the number of the belonging physical cores 401 is greater than the minimum number of physical cores during system failure 402”. In the physical core group management information 110 (FIG. 4), with respect to the physical core group 0, there are four belonging physical cores 401, “4, 5, 6, 7”, and the minimum number of physical cores during system failure 402 is “3”. Thus, the physical core group 0 meets the condition that “the number of the belonging physical cores 401 (four physical cores) is greater than the minimum number of physical cores during system failure 402 (three physical cores). Then, the physical core group 0 is detected by the resource control unit 121.

In Step 731, the resource control unit 121 determines whether or not there is a physical core group that meets the condition that “the number of the belonging physical cores 401 is greater than the minimum number of physical cores during system failure” as a result of the search in Step 730. As a result of the determination, the physical core group 0 meets the condition as a result of the determination, so that the resource control unit 121 proceeds to Step 740.

In Step 740, the resource control unit 121 refers to the physical core group management information 110 (FIG. 4), and selects the physical core 4 164 as a spare physical core, among the physical cores identified by “4, 5, 6, 7” corresponding to the belonging physical cores 401 of the physical core group 0 that is detected in Step 730.

In Step 741, the resource control unit 121 distributes the arithmetic processing on the physical core 4 164 to the physical cores 5 to 7 (165 to 167) other than the physical core 4 164, which is the spare physical core, among the belonging physical core 401 of the physical core group 0. The resource control unit 121 stops the arithmetic processing of the physical core 4 164 which is the spare physical core.

In Step 742, the resource control unit 121 excludes the physical core 4 164, which is the spare physical core, from the physical core group 0, and the proceeds to Step 720. The resource control unit 121 updates the belonging physical core 401 corresponding to the physical core group 0 of the physical core group management information 110 (FIG. 4) to “5, 6, 7” in such a way that the identifier “4” is excluded from “4, 5, 6, 7”.

In Step 720, the resource control unit 121 shifts the arithmetic processing from the physical core 0 160, which is the failed physical core, to the physical core 4 164 which is the spare physical core.

In Step 721, the resource control unit 121 refers to the logical core management information 113 (FIG. 5) to change the allocation from the physical core 0 160 to the physical core 4 164 which is the spare physical core, with respect to the logical core “0” mapped to the “physical core 0”, which is the failed physical core. The resource control unit 121 updates the corresponding physical core 502 corresponding to the logical core 0 of the logical core management information 113 (FIG. 5), from the “physical core 0”, which is the failed physical core, to the “physical core 4” which is the spare physical core.

In Step 722, the resource control unit 121 changes the state of the physical core 0 160, which is the failed physical core, to Degenerate. The resource control unit 121 updates the “physical core state” 301 mapped to the physical core 0 of the physical core management information 111 (FIG. 3), from “Normal” to “Degenerate”.

In Step 723, the resource control unit 121 issues an alert notification request to the input/output control unit 120 to notify that the allocation has been switched to the physical core 4 164, which is the spare physical core, from the physical core 0 160 which is the failed physical core. In response to the alert notification request, the input/output unit 120 displays the screen in the terminal 101 through the connection unit 173 to notify that the configuration of the LPAR 0 130 and the configuration of the LPARs 2 to 4 (132 to 134) were changed because the failed physical core was detected. As a specific example, the screen to notify that the allocation of the physical core to the logical core 0 150 of the LPAR 0 130 was changed from the physical core 0 160, which is the failed physical core, to the physical core 4 164 which is the spare physical core.

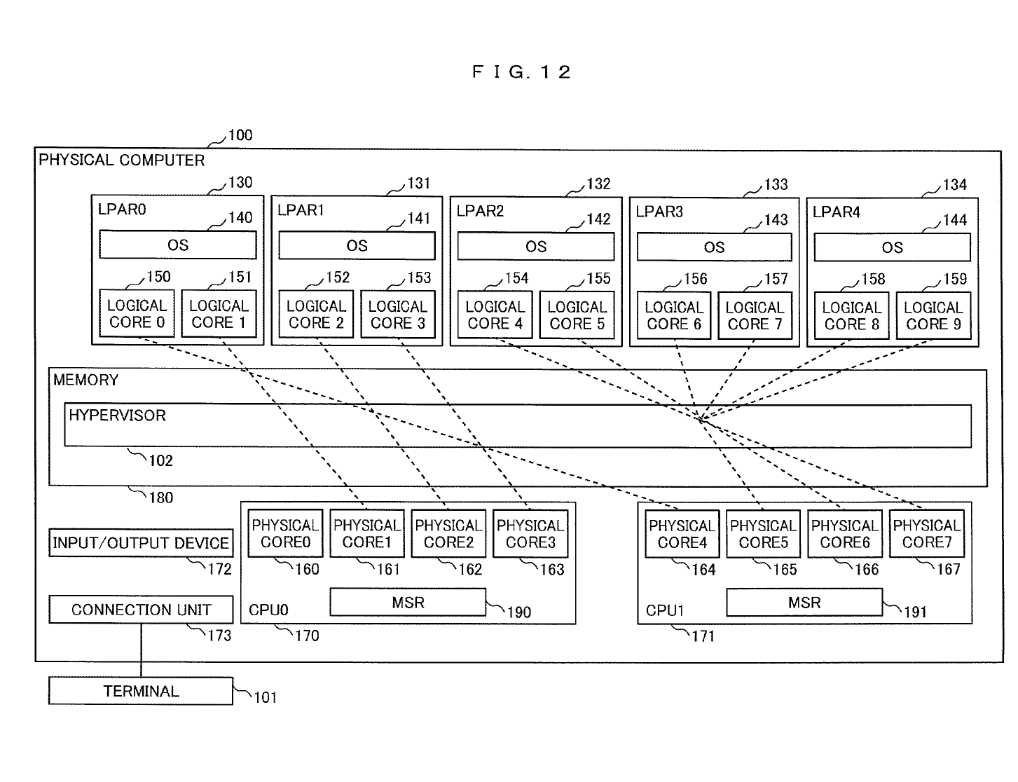

FIG. 12 is a diagram showing the configuration of the computer system after the control by the resource control unit 121 as described above, when CE often occurred in the physical core 0 160 and, as a result, the physical core 0 160 becomes a failed physical core. Compared to FIG. 1 which is the state before the control by the resource control unit 121 as described above, the configuration of the computer system shown in FIG. 12 is changed in the allocation of the physical core to the logical core 0 150 from the physical core 0 160 to the physical core 4 164. This is the state with no logical core allocated to the physical core 0 160 which is the failed physical core. Further, the physical cores configuring the physical core group 0 allocated to the logical cores 4 to 9 (154 to 159) are changed from the physical cores 4 to 7 (164 to 167) to the physical cores 5 to 7 (165 to 167).

The description will assume that in the sequence diagram of FIGS. 8 to 11 with the configuration of the computer system of FIG. 12, CE often occurred in the physical core 1 161 and, as a result, the physical core 1 161 becomes a failed physical core.

In Step 700, the resource control unit 121 refers to the MSR 190 of the CPU 0 170 to obtain the number of occurrences of CE in the physical core 1 161. The resource control unit 121 maps “1”, which is the identifier of the physical core 1 161, to the CE count 302 of the physical core management information 111. Then, the resource control unit 121 records the obtained number of occurrences of CE. Here, as an example, the obtained number of occurrences of CE is “100”.

In Step 701, the resource control unit 121 refers to the physical core management information 111 to obtain the CE count 302 of the physical core 1 161.

In Step 702, the resource control unit 121 compares the CE count 302 and the CE count threshold 123 with respect to the physical core 1 161. The CE count 302 of the physical core 1 161 increases from “1” in FIG. 3 to “100”, so that the resource control unit 121 determines that the CE count 302 of the physical core 1 161 exceeds the CE count threshold 123, and proceeds to Step 703.

In Step 703, the resource control unit 121 refers to the column 401 of the belonging physical core of the physical core group management information 110 as well as the column 502 of the corresponding physical core of the logical core management information 113, to search for a non-belonging physical core among the physical cores 0 to 7 (160 to 167). As a result of the search, the physical core 0 160 is detected as the non-belonging physical core.

The resource control unit 121 refers to the physical core management information 111 to determine whether or not the “physical core state” 301 of the physical core 0 160, which is the non-belonging physical core, is normal. The resource control unit 121 determines that the “physical core state” 301 of the physical core 0 160 is “degenerate” and is not normal.

In Step 704, as a result of the search in Step 703, there is no normal non-belonging physical core, so that the resource control unit 121 proceeds to Step 730.

In Step 730, the resource control unit 121 refers to the physical core group management information 110 to search for a physical core group that meets the condition that “the number of the belonging physical cores 401 is greater than the minimum number of physical cores during system failure 402”. Here, in the configuration of the computer system shown in FIG. 12, in the physical core group management information 110 with respect to the physical core group 0, there are three belonging physical cores 401, “5, 6, 7”, and the minimum number of physical cores during system failure 402 is “3”. As a result, the physical core group 0 does not meet the condition that “the number of the belonging physical cores 401 is greater than the minimum number of physical cores during system failure 402”.

In Step 731, the resource control unit 121 determines that there is no physical core group that meets the condition that “the number of the belonging physical cores 401 is greater than the minimum number of physical cores during system failure” as a result of the search in Step 730, and proceeds to Step 732.

In Step 732, the resource control unit 121 refers to the physical core group management information 110, the LPAR management information 112, and the logical core management information 113, to search for an LPAR that meets the condition that “the number of physical cores allocated to the logical cores possessed by the LPAR is greater than the minimum number of physical cores during system failure 603”.

As a specific example, the resource control unit 121 refers to the LPAR management information 112 (FIG. 6) to obtain the identifiers of the logical cores 2 and 3 (152 and 153) as the logical cores 601 possessed by the LPAR 1 131. The resource control unit 121 refers to the logical core management information 113, and obtains the information of the physical core 2 162 and the physical core 3 163, as the corresponding physical cores 502 mapped to the identifiers of the logical cores 2 and 3 (152 and 153). Thus, the LPAR 1 meets the condition that “the number of the physical cores 2 and 3 (162 and 163) (two) that are allocated to the logical cores 2 and 3 (152 and 153) possessed by the LPAR 1 is greater than the minimum number of physical cores during system failure 603 (one)”. Then, the LPAR 1 is detected by the resource control unit 121.

In Step 733, the resource control unit 121 determines that the LPAR 1 131 meets the condition that “the number of physical cores allocated to the logical cores possessed by the LPAR is greater than the minimum number of physical cores during system failure 603” as a result of the search in Step 732. Then, the resource control unit 121 proceeds to Step 750.

In Step 750, the resource control unit 121 defines the LPAR 1 131 that was detected as a result of the search in Step 732, as a spare physical core supply LPAR.

In Step 751, the resource control unit 121 selects the physical core 2 162 of the physical cores 2 and 3 (162 and 163) allocated to the logical cores 2 and 3 (152 and 153) possessed by the LPAR 1 131, which is the spare physical core supply LPAR, as a spare physical core.

In Step 752, the resource control unit 121 refers to the LPAR management information 112 and finds that the value of the “keep up the number of logical cores by sharing physical cores” 602 is Yes for the LPAR 1 131, which is the spare physical core supply LPAR. Thus, the resource control unit 121 proceeds to Step 753.

In Step 753, the resource control unit 121 adds the physical core 3 163, as a physical core group 1, which is all physical core other than the physical core 2 162 which is the spare physical core, of the physical cores 2 and 3 (162 and 163) allocated to the logical cores 2 and 3 (152 and 153) of the LPAR 1 131, which is the spare core supply LPAR, to the physical core group management information 110. Further, the minimum number of physical cores during system failure 402 inherits the value “1” of the minimum number of physical cores during system failure 603 for the spare physical core supply LPAR.

FIG. 14 is a diagram showing the configuration of the physical core group management information 110 in which the physical core group 1 at this time is added. When compared to the state of FIG. 4, with respect to the physical core group management information 110 shown in FIG. 14, “1” for the entry 400 as the identifier to identify the physical core group 1, “3” for the entry 401 as the identifier of the belonging physical core 401, and “1” for the minimum number of physical cores during system failure 402 are stored in association with each other. Further, the value of the belonging physical core 401 is changed to “5, 6, 7” with respect to the physical core group 0.

In Step 754, the resource control unit 121 allocates all the logical cores 2 and 3 (152 and 153) belonging to the LPAR 1, which is the spare physical core supply LPAR, to the physical core group 1 (physical core 3 163 which is all physical core other than the physical core 2 162 which is the spare physical core) that was added in Step 753. The resource control unit 121 records the physical core group 1 into the corresponding physical core 502 which corresponds to the logical cores 2 and 3 (152 and 153) in the logical core management information 113. Then, the resource control unit 121 changes the resource allocation method 501 to SHARED.

In Step 755, the resource control unit 121 distributes the arithmetic processing on the spare physical core with SHARED mode to the physical core group 1 (physical core 3 163) that was added in Step 753. Then, the resource control unit 121 stops the arithmetic processing on the physical core 2 162, which is the spare physical core, and then proceeds to Step 720.

In Step 720, the resource control unit 121 shifts the arithmetic processing from the physical core 1 161, which is the failed physical core, to the physical core 2 162 which is the spare physical core.

In Step 721, the resource control unit 121 refers to the logical core management information 113, to change the allocation with respect to the physical core allocated to the logical core 1 151 mapped to the “physical core 1”, which is the failed physical core, from the physical core 1 151 to the physical core 2 162 which is the spare physical core. The resource control unit 121 updates with respect to the corresponding physical core 502 mapped to the logical core 1 of the logical core management information 113, from the “physical core 1”, which is the failed physical core, to the “physical core 2” which is the spare physical core.

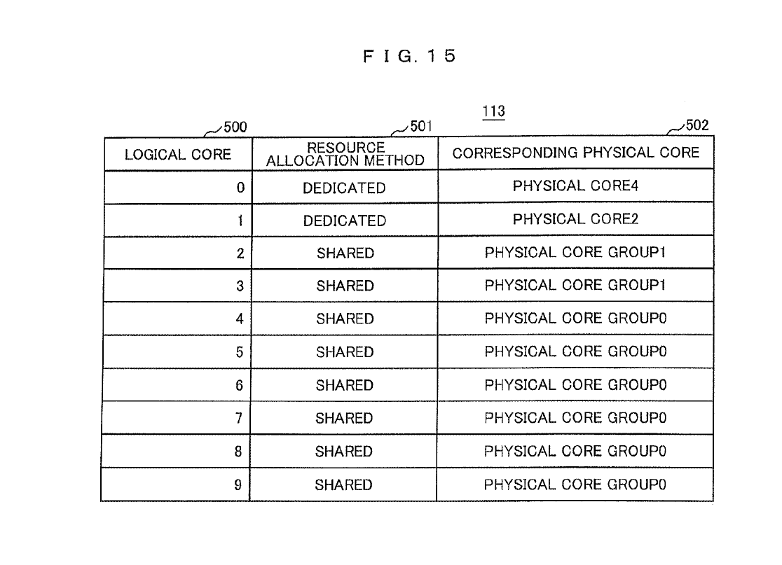

FIG. 15 is a diagram showing the configuration of the logical core management information 113 at this time. When compared to the state of FIG. 5, in the logical core management information 113 shown in FIG. 15, the resource allocation method 501 mapped to the entry 500 of the identifier of the logical cores 2 and 3 (150 and 151) is changed to “shared”, and the corresponding physical core 502 is changed to “physical core group 1”. Further, with respect to the logical core 0 150 and the logical core 1 151, the corresponding physical core 502 is changed to “physical core 4” and to “physical core 2”, respectively.

In Step 722, the resource control unit 121 changes the state of the physical core 1 161, which is the failed physical core, to DEGENERATE. The resource control unit 121 updates with respect to the “physical core state” 301 mapped to the physical core 1 of the physical core management information 111, from “normal” to “degenerate”.

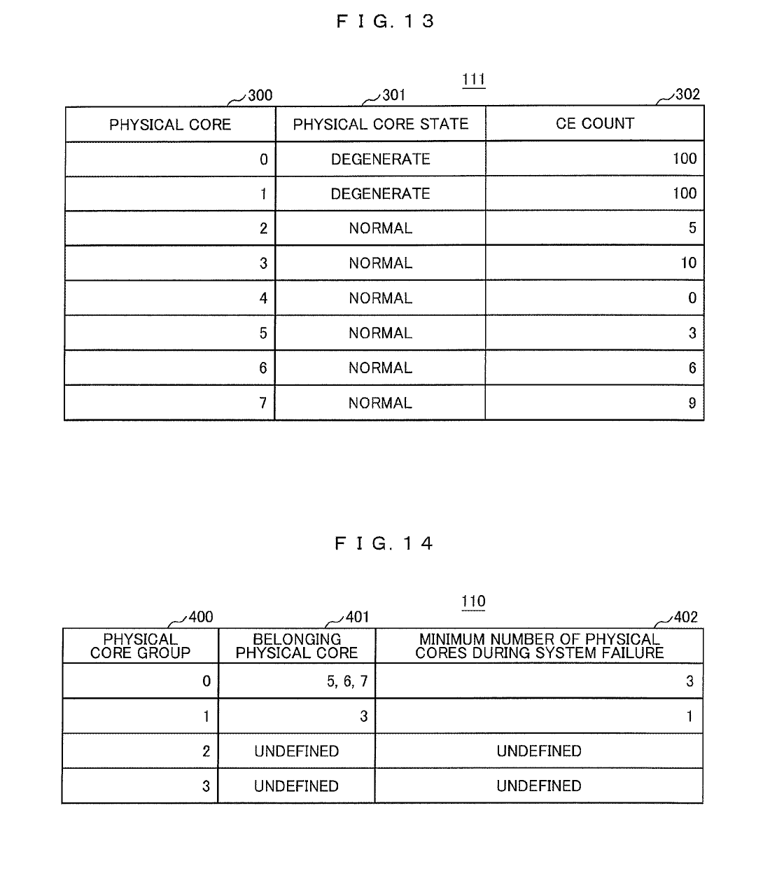

FIG. 13 is a diagram showing the configuration of the physical core management information 111 at this time. When compared to the state of FIG. 3, with respect to the physical core management information 111 shown in FIG. 13, the physical core state 301, which is mapped to the entry 300 of the identifier to identify the physical core 0 160, is changed to “degenerate”. Further, with respect to the physical core 1 161, the physical core state 301 is changed to “degenerate” and the CE count 302 is changed to “100”.

In Step 723, the resource control unit 121 issues an alert notification request to the input/output control unit 120, to notify that the physical core 1 161, which is the failed physical core, was switched to the physical core 2 162 which was the spare physical core. In response to the alert notification request, the input/output control unit 120 displays the screen in the terminal 101 through the connection unit 173, to notify that the configuration of the LPAR 0 130 and the configuration of the LPAR 1 141 were changed because the failed physical core was detected. As a specific example, the screen to notify that the allocation of the physical core to the logical core 1 151 of the LPAR 0 130 was changed from the physical core 1 161, which is the failed physical core, to the physical core 2 162 which is the spare physical core, because the failure physical core was detected.

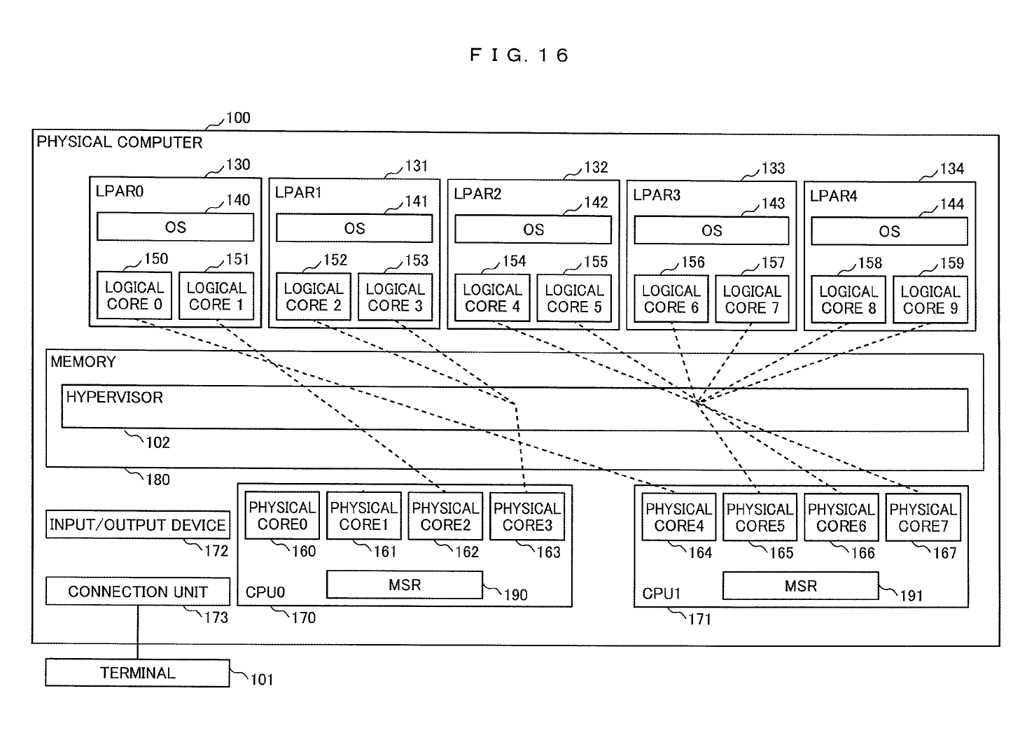

FIG. 16 is a diagram showing the configuration of the computer system after the control by the resource control unit when the physical core 0 and the physical core 1 become failed physical cores. Compared to FIG. 12 which is the configuration of the computer system when only the physical core 0 160 becomes a failed physical core, with respect to the configuration of the computer system shown in FIG. 16, the allocation of the physical core to the logical core 1 151 is changed from the physical core 161 to the physical core 2 162. This is the state with no logical core allocated to the physical core 1 161 which is the failed physical core. Further, the physical core 3 163 configuring the physical core group 1 is allocated to the logical cores 2 and 3 (152 and 153).

In the embodiment described above, it is assumed that CE often occurred in the physical core 0 160 and the physical core 1 161 and, as a result, they become failed physical cores. However, when CE often occurred in any one of the physical cores and the particular physical core becomes a failed physical core and degenerate, there is no change in the number of logical cores to be allocated to any of the LPARS due to the operation of the resource control unit 121 in the sequence shown in FIGS. 8 to 11. Thus, the number of cores recognized by the OS running on the LPAR is not changed. Further, also in the embodiment described above, before and after the physical core 0 160 and the physical core 1 161 become failed physical cores, the content of the LPAR management information 112 of FIG. 6 is not changed, so that there is no change in the number of logical cores (two) possessed by the respective LPARs 0 to 4 (130 to 134).

Thus, if the physical computer 100 does not have (use) a normal physical core which is not allocated to any specific logical core as a spare and, in this state, if a physical core is degenerate due to a failure such as frequent occurrence of CE in the physical core, the number of logical cores can be kept only with other physical cores in which no failure occurred. Thus, the number of logical cores recognized by the OS running on the LPAR is not changed, and the operation of the virtual computer system of the physical computer 100 can be maintained. Thus, it is possible to maintain the operation even if the OS is unable to keep running when the number of logical cores recognized by the OS is changed.

Further, the LPAR 0 130 having the logical cores 0 and 1 (150 and 151) allocated to the physical cores 0 and 1 (160 and 161) in which failure occurred as shown in FIG. 1, is put into a state in which the normal physical cores 2 and 4 (162 and 164) are allocated with DEDICATED as shown in FIG. 16 after the control by the resource control unit 121. Thus, the number of physical cores to be allocated with DEDICATED is not changed before and after the occurrence of failure in the physical cores 0 and 1 (160 and 161), so that it is possible to maintain the performance of the LPAR 0 130. Thus, it is possible to solve the problem of the deterioration of the performance in the LPAR using physical cores degenerate and closed due to the failure.

The present embodiment assumes the case where CE often occurred in a physical core as the failure. However, the configuration and method shown in the present embodiment can be applied as long as the failure permits the physical core to be switched to another physical core. Further, in the present embodiment, it is also possible that the “failure” is the condition in which failure is expected.

In the present embodiment, in the steps of selecting a spare physical core by the resource control unit 121 in an excess of CE occurred in a physical core, including Step 710, Step 740, and Step 751 within the sequence (FIGS. 8 to 11) of the resource control unit 121, the spare physical core selection can be prioritized based on the performance characteristics according to the user specification or the hardware structure (such as preferentially allocating when it is the same NUMA group in the physical cores belonging to the physical core group or the LPAR which is the switching destination of the spare physical core).

### REFERENCE SIGNS LIST

100 physical computer
101 terminal
102 hypervisor
110 physical core group management information
111 physical core management information
112 LPAR management information
113 logical core management information
120 input/output control unit
121 resource control unit
122 resource management information
123 CE count threshold
130 to 134 LPAR
140 to 144 OS
150 to 159 logical core
160 to 167 physical core
170 to 171 CPU
172 input/output device
173 connection unit
180 memory
190 to 191 MSR

1. A computer comprising:
a plurality of physical cores;
a first virtual computer including a first logical core to which a first physical core is allocated;
a second virtual computer including one or more logical cores to which a plurality of physical cores are allocated; and
a hypervisor which:
when a failure occurs in the first physical core, allocates, to the one or more logical cores, a physical core other than a second physical core among the plurality of physical cores allocated to the one or more logical cores possessed by the second virtual computer; and
changes the physical core to be allocated to the first logical core, from the first physical core to the second physical core.

2. The computer according to claim 1,
wherein the computer comprises a storage unit including virtual computer management information to manage information that manages whether or not the number of logical cores is maintained by sharing physical cores, for each virtual computer, and
wherein when a failure occurs in the first physical core, the hypervisor refers to the virtual computer management information, and when the second virtual computer keeps the number of logical cores with physical core shared, the hypervisor allocates a physical core other than the second physical core among the plurality of physical cores allocated to the one or more logical cores possessed by the second virtual computer, to the one or more logical cores with shared.

3. The computer according to claim 2,
wherein when a failure occurs in the first physical core, the hypervisor refers to the virtual computer management information, and when the second virtual computer does not keep the number of logical cores with physical cores shared, the hypervisor excludes the second physical core from the allocation of the one or more logical cores possessed by the second virtual computer.

4. The computer according to claim 2,
wherein the virtual computer management information manages the minimum number of physical cores for each virtual computer, and
wherein when a failure occurs in the first physical core, the hypervisor refers to the virtual computer management information to search for the second virtual computer in which the number of physical cores allocated to the one or more logical cores is greater than the minimum number of physical cores of the virtual computer.

5. The computer according to claim 4,
wherein when a failure occurs in the first physical core, the hypervisor refers to the virtual computer management information, and when the second virtual computer, in which the number of physical cores allocated to the one or more logical core is greater than the minimum number of physical cores of the virtual computer, was not detected, the hypervisor issues a failure notification request.

6. The computer according to claim 1,
wherein the hypervisor changes the physical core to be allocated to the first logical core, to the second physical core from the first physical core in which the failure occurred, and then issues an alert notification request.

7. The computer according to claim 1,
wherein when the number of occurrences of error in the first physical core exceeds a predetermined value, it is determined that the failure occurred in the first physical core.

8. The computer according to claim 1,
wherein the computer comprises a storage unit including resource management information to manage the allocation between the physical core and the logical core,
wherein when a failure occurs in the first physical core, the hypervisor refers to the resource management information, and when there is a third physical core that is not allocated to any of the logical cores included in the computer, the hypervisor changes the physical core to be allocated to the first logical core, to the third physical core from the first physical core in which the failure occurred.

9. The computer according to claim 8,
wherein when a failure occurs in the first physical core and when the third physical core is present, the hypervisor sets the physical core to be allocated to the first logical core, to the third physical core instead of the second physical core.

10. The computer according to claim 8,
wherein the storage unit includes physical core management information that manages the physical core state for each physical core, and
wherein when a failure occurs in the first physical core, the hypervisor refers to the physical core management information, and selects the physical core in normal state that is not allocated to any of the logical cores, as the third physical core.

11. The computer according to claim 1,
wherein the hypervisor changes the physical core to be allocated to the first logical core, to the physical core other than the first physical core from the first physical core in which the failure occurred, and then degenerates the first physical core.

12. The computer according to claim 1,
wherein the computer comprises:
a first physical core group including the plurality of physical cores; and
a storage unit including physical core group management information that manages the minimum number of physical cores for each physical core group,
wherein when a failure occurs in the first physical core, the hypervisor:
refers to the physical core group management information to search for the first physical core group in which the number of physical cores possessed by the physical core group is greater than the minimum number of physical cores of the particular physical core group;
excludes a fourth physical core, which is one of the plurality of physical cores possessed by the first physical core group that was searched for, from the first physical core group; and
changes the physical core to be allocated to the first logical core, to the fourth physical core from the first physical core in which the failure occurred.

13. A hypervisor comprising:
allocating a first physical core to a first logical core possessed by a first virtual computer;
allocating a plurality of physical cores to one or more logical cores possessed by a second virtual computer;
when a failure occurs in the first physical core, allocating, to the one or more logical cores, a physical core other than the second physical core among the plurality of physical cores allocated to the one or more logical cores possessed by the second virtual computer; and
changing the physical core to be allocated to the first logical core, to the second physical core from the first physical core in which the failure occurred.

14. A method of allocating physical cores in a computer comprising a plurality of physical cores, a plurality of logical cores, and a hypervisor for allocating the physical cores to the logical cores,
wherein the hypervisor:
allocates a first physical core to a first logical core possessed by a first virtual computer;
allocates a plurality of physical cores to one or more logical cores possessed by a second virtual computer;
when a failure occurs in the first physical core, allocates a physical core other than a second physical core among the plurality of physical cores allocated to the one or more logical cores possessed by the second virtual computer, to the one or more logical cores; and
changes the physical core to be allocated to the first logical core, to the second physical core from the first physical core in which the failure occurred.
